(19) United States
(12) Patent Application Publication
(10) Pub. No.: US 2026/0171447 A1
(43) Pub. Date: Jun. 18, 2026

(54) Method and Device for Operating a Fuel Cell System

(71) Applicant: Bayerische Motoren Werke Aktiengesellschaft, Muenchen (DE)

(72) Inventor: Thomas RAUH, Eching (DE)

(21) Appl. No.: 19/126,280

(22) PCT Filed: Nov. 2, 2023
(86) PCT No.: PCT/DE2023/100801

§ 371 Date: May 1, 2025

(30) Foreign Application Priority Data
Nov. 2, 2022 (DE) 10 2022 128 924.9

(51) Int. Cl. H01M 8/04223; H01M 8/04089

(52) U.S. Cl. CPC H01M 8/04231; H01M 8/04097

(57) ABSTRACT

Devices for operating fuel cell systems, the fuel cell systems including a stack of fuel cells and an anode subsystem for receiving the fuel for the stack, are provided herein. Methods for operating fuel cell systems are further provided.

### BACKGROUND AND SUMMARY

The present disclosure relates to a method and a corresponding device for operating a fuel cell system, in particular taking into account purges for draining water from the anodes in the stack of fuel cells forming the fuel cell system.

Electric vehicles may contain a stack of one or more fuel cells designed to generate electricity from a fuel, in particular hydrogen, for the electric machine that drives the vehicle. The fuel is typically provided to the fuel cells from a pressure tank. A valve regulates the amount of fuel supplied to the fuel cells.

The amount of fuel supplied to the fuel cells affects the amount of electricity that is generated. Increasing the amount of fuel normally increases the amount of electricity, providing the vehicle with more power.

If too much fuel is supplied to the fuel cells, the concentration of fuel in the exhaust from the fuel cells is increased, thus impacting the efficiency of the fuel cells. For this reason, it is usually advantageous to coordinate the amount of fuel supplied to the fuel cells to the current state of the anodes in the fuel cells, in particular to the current concentration of fuel at the anodes.

A dedicated concentration sensor can be used determine the state of the anodes, in particular to determine the concentration of fuel at the anodes, although a dedicated concentration sensor is associated with additional costs and requires more space. A mathematical operating model can also be used to estimate the state of the anode and the concentration of fuel. The state of the anode determined using a model may not be precise, and typically depends on the initialization of the operating model.

One object of the present disclosure is to reduce or eliminate at least one disadvantage of the art, or propose an alternative solution. Another object of the present disclosure is to determine and/or optimize the concentration of fuel at the anodes in a stack of fuel cells, to obtain an efficient and reliable operation thereof.

These problems are solved by the subject matter of the present disclosure.

One aspect of the present disclosure relates to a device for operating a fuel cell system. The fuel cell system contains a stack of fuel cells and an anode subsystem for receiving fuel (in particular H₂) for the fuel cells. The anode subsystem may contain a water trap for removing water from the fuel cell exhaust. The anode subsystem may also contain a purge valve through which this water is removed. The device can be configured to open the purge valve to drain the water from the anode subsystem.

Purges can thus be used to remove water from the anode subsystem. One or more operating parameters can be adjusted for the purges, for example, the length and/or repetition rate thereof. An accumulation of water in the fuel cell anodes, and an associated shortage of fuel to the anodes, which would have a negative impact on the performance thereof, can be prevented by the repeated effects of the purges. However, too many purges will reduce the efficiency of the fuel cell system (because some fuel may be lost through the purge valve). The device described herein can be configured to obtain a particularly efficient and fuel-efficient operation of the fuel cell system.

With the present design of anode subsystem, after a first phase of a purge in which substantially only water is removed from the anode subsystem, fuel is then removed in at least one subsequent phase (if the overall length of the purge is longer than the first phase). Removing fuel can impact the efficiency of the fuel cell system.

The anode subsystem can also be designed the pressure in the supply line to the anodes in the fuel cells and/or the pressure in the exhaust line from the anodes is reduced during a subsequent (second or third) phase of a purge (in comparison with the pressure during the first phase), in which fuel is removed from the anode subsystem. This pressure drop is obtained in the (second or third) phase of the purge by removing fuel (through the purge valve) directly from the anode subsystem, such that the gas pressure in the supply line and/or exhaust line decreases. This pressure drop can be used to analyze purges.

The device is designed to determine changes in pressure in the anode subsystem (for example, the supply line and/or exhaust line) during at least one previous purge. The anode subsystem can contain at least one pressure sensor for detecting the pressure in the supply line and/or the exhaust line. The device can be configured to determine the changes in pressure in the anode subsystem during the previous purge based on sensor data from the pressure sensor.

The device is also configured to determine one or more operating parameters for the fuel cell system (in particular one or more operating parameters relating to the purging of the fuel cell system) based on the changes in pressure (during the previous purge). The one or more operating parameters may comprise parameters for subsequent purges. The operating parameters may be adjusted (for example, regulated) during the subsequent purges (based on the detected pressures during the previous purges). This efficiently and reliably prevents accumulation of water in the anode.

The one or more operating parameters for the fuel cell system can be
the length of at least one subsequent purge; and/or
the time between the subsequent purge and the previous purge; and/or
the repetition rate for one or more subsequent purges; and/or
the pressure in the anode subsystem (in particular in the supply line); and/or
the electricity generated by the fuel cells.

The device is therefore configured to evaluate the changes in pressure in the anode subsystem during a previous purge to adjust subsequent operation of the fuel cell system resulting in a particularly efficient, reliable, and fuel-efficient operation of the fuel system. This also reliably prevents a shortage of fuel in the fuel cell anodes. This furthermore prevents excessive fuel consumption.

The device can be configured to determine whether the previous purge contained at least one (second or third) phase in which fuel was removed from the anode subsystem based on the changes in pressure. The one or more operating parameters for the fuel cell system can then be efficiently and reliably determined from whether the previous purge contained at least one phase in which fuel was removed from the anode subsystem.

The device can be configured to determine one or more properties of the previous purge based on the changes in pressure. The one or more properties can be determined by comparing the changes in pressure with one or more threshold values. The one or more properties can be
whether the previous purge comprised just one phase in which substantially only water was removed from the anode subsystem;
whether the previous purge also contained a second phase in which fuel was also removed from the anode subsystem;
whether the previous purge contained a third phase, in which substantially only fuel was removed from the anode subsystem; and/or
the lengths of the first, second and/or third phases.

The one or more operating parameters for the fuel cell system can then be efficiently and precisely determined and/or adjusted based on the one or more properties of the previous purge.

The device can be configured to compare the changes in pressure with at least one threshold value. The one or more operating parameters for the fuel cell system can then be determined on the basis of the comparison.

The device can be configured in particular to compare the changes in pressure with a first threshold value. By this means, it can be determined whether the previous purge contained a second phase (in addition to a first), in which fuel was also removed, in addition to the water, from the anode subsystem. The length of the second phase can also be determined.

The device can also be configured to compare the changes in pressure with a second threshold value, which is lower than the first. By this means, it can be determined whether the previous purge contained a third phase (in addition to a first and second), in which substantially only fuel was removed from the anode subsystem. The length of the third phase can also be determined.

By making one or more threshold comparisons, one or more properties of the previous purge can be particularly efficiently and precisely determined.

As explained above, one or more operating parameters can be determined and/or adjusted for the subsequent operation of the fuel cell system based on the one or more properties of the previous purge. The device can be configured to increase the length and/or repetition rate of one or more subsequent purges, and/or reduce the time between the one or more subsequent purges, if the previous purge only contained one phase. This reduces the risk of fuel shortage. The device can also be configured to reduce the length and/or repetition rate of one or more subsequent purges, and/or increase the time between the one or more subsequent purges, if the previous purge contained a third phase. This increases the fuel efficiency of the fuel cell system.

The measures described herein can be repeated over time. In doing so, one or more previous purges can be analyzed with regard to changes in pressure. The subsequent operation of the fuel cell system can be adjusted on the basis of the analysis of the one or more previous purges. This results in a more efficient and reliable operation over time.

The device can be configured to determine the one or more operating parameters for the fuel cell system to ensure that a (second) phase in at least one subsequent purge, in which fuel is removed from the anode subsystem, is of a specific target length (of zero, or close to zero). Consequently, the length of the second phase in one or more subsequent purges can be regulated to a specific target value, based on the changes in pressure in one or more previous purges. This results in a particularly efficient and reliable operation of the fuel cell system.

An external (dynamic) event during the operation of the fuel cell system may affect the pressure (in the supply line and/or the exhaust line). This may be the case in particular when operating the fuel cell system in a motor vehicle. This external event may occur during a purge, thus distorting the changes in pressure determined during the purge.

The device can be configured to check whether the changes in pressure detected during the previous purge are distorted or not, in particular due to an external, dynamic event. These changes in pressure can be compared with one or more reference graphs (in which the changes in pressure are not distorted). The purge can then be classified as either having distorted or not distorted changes in pressure.

The changes in pressure can then be used during the determination of one or more operating parameters for the fuel cell system based on whether the changes in pressure that have been detected (in other words, classified) were distorted or not. In particular, the changes in pressure can be taken into account based on whether they were detected (in other words, classified) as distorted or not.

By identifying and taking distorted changes in pressure into account, the reliability of the operation of the fuel cell system can be further improved. The device can be configured, for example, to determine (in general) if the previous purge does not include a phase in which fuel is removed from the anode subsystem (in other words, the purge only has a first phase), if it has been determined that the changes in pressure in the previous purge were distorted. This efficiently increases the reliability of the operation of the fuel cell system.

Another aspect of the present disclosure relates to a fuel cell system that contains the device described above.

Another aspect of the present disclosure relates to a (street) motor vehicle (in particular a passenger automobile, truck, bus, or motorcycle) that contains the device and/or the fuel cell system described herein.

Another aspect of the present disclosure relates to a method for operating a fuel cell system that contains a stack of fuel cells and an anode subsystem for receiving fuel for the fuel cells. The method comprises determining the changes in pressure in the anode subsystem during at least one purge (in which water is removed from the anode subsystem). The method also comprises determining one or more operating parameters for the fuel cell system based on the changes in pressure over time. The one or more operating parameters for the fuel cell system can contain one or more operating parameters for one or more subsequent purges.

Another aspect of the present disclosure relates to a software (SW) program. The SW program can be run on a processor (for example, a control unit in a vehicle), to execute the method described herein.

Another aspect of the present disclosure relates to a memory. The memory can contain the SW program that can be run on a processor to execute the method described herein.

It should be noted that the methods, devices, and systems described herein can be used in and of themselves, as well as in combination with other methods, devices, and systems described herein. Moreover, any aspects of the methods, devices and systems described herein may be combined in a variety of ways. In particular, the features in the claims can be combined in a variety of ways. Furthermore, features in parentheses are to be regarded as optional.

The present disclosure shall be described in greater detail below based on exemplary embodiments. In the drawings:

### BRIEF DESCRIPTION OF THE DRAWINGS

FIG. 1 shows an exemplary fuel cell system with a stack of fuel cells;

FIG. 2 shows an exemplary structure for a fuel cell;

FIG. 3 shows an exemplary stack of fuel cells from the side;

FIG. 4 shows an exemplary stack of fuel cells from the front;

FIG. 5 shows an exemplary anode subsystem in a stack of fuel cells;

FIG. 6a shows an exemplary graph of the changes in pressure at the anode intake or anode discharge in a stack of fuel cells;

FIG. 6b shows an exemplary graph of a sequence of purges during operation of a stack of fuel cells; and

FIG. 7 shows a flow chart for an exemplary method for operating a stack of fuel cells.

### DETAILED DESCRIPTION OF THE DRAWINGS

As explained above, the present disclosure relates to obtaining an efficient and reliable operation of a stack of fuel cells, in particular with regard to supplying fuel to the anodes in the fuel cells.

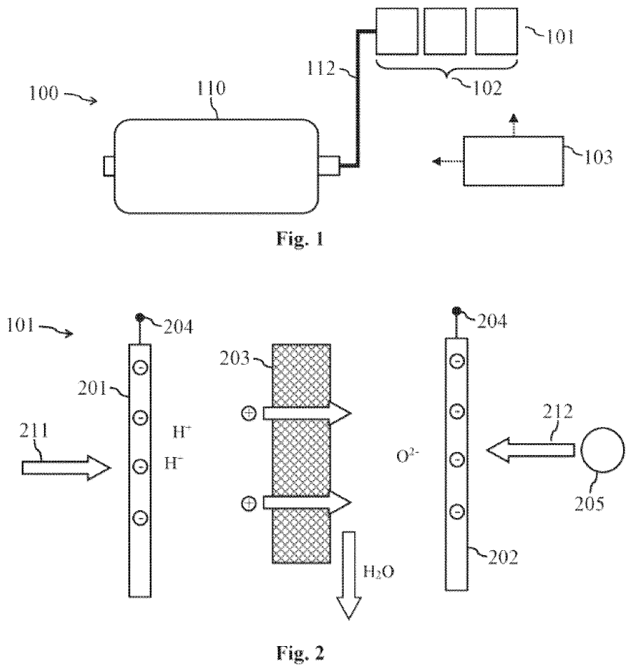

FIG. 1 shows a fuel cell system 100 with a stack of fuel cells 102 containing at least one fuel cell 101. The fuel cell system 100 is intended for use in motor vehicles, in particular for powering at least one electric drive in a motor vehicle. A fuel cell 101 converts fuel and oxidizers into reaction products, thus electrochemically producing electricity and heat. A fuel cell 101 contains (as shown in FIG. 2) an anode 201 and a cathode 202, separated by a separator 203 that is semipermeable or impermeable to ions. The anodes 201 are supplied with fuel 211. Preferred fuels 211 are: hydrogen (H₂), low molecular weight alcohols, biofuels, or liquid natural gas. The cathodes 202 are supplied with oxidizers 212. Preferred oxidizers 212 are: air, oxygen, and peroxide. The ion-selective separator 203 can form a proton-exchange membrane (PEM). A cation-selective polymer electrolyte membrane is preferably used. This membrane is preferably made of Nafion®, Flemion®, and Aciplex®.

Fuel cell systems 100 contain, in addition to the at least one fuel cell 101, peripheral components (balance of plant (BOP) components), that are used to operate the at least one fuel cell 101. A fuel cell stack 102 normally contains numerous fuel cells 101. The fuel cell system also normally contains at least one pressure tank 110 with which the fuel cells 101 are supplied with fuel 211. The pressure tank 110 is connected to the one or more fuel cells 101 by one or more lines 112.

The anodes 201 and cathodes 202 in a fuel cell 101 or stack 102 of fuel cells can be connected to contacts 204. These contacts 204 are normally connected to an operating voltage (for example, about 1V for one fuel cell 101) for supplying electricity. By connecting numerous fuel cells 101 in a series (in other words, to obtain a stack 102 of fuel cells), the operating voltage for the stack 102 can be increased.

Each of the fuel cells 101 in the stack 102 normally contains two separator plates (not shown). The ion-selective separator 203 in a fuel cell 101 is normally placed between two separator plates. One separator plate, together with the ion-selective separator 203 forms the anode 201. The second separator plate on the other side of the ion-selective separator 203 forms the cathode 202 with the ion-selective separator 203. There are preferably gas channels in the separator plates for fuel 211 or oxidizers 212.

The separator plates can be monopolar plates and/or bipolar plates. In other words, each separator plate has two sides, one side of which forms the anode 201 with an ion-selective separator 203 in a first fuel cell 101, while the other side forms the cathode 202 with another ion-selective separator 203 in an adjacent fuel cell 101.

There are normally gas diffusion layers (GDL) between the ion-selective separators 203 and the separator plates.

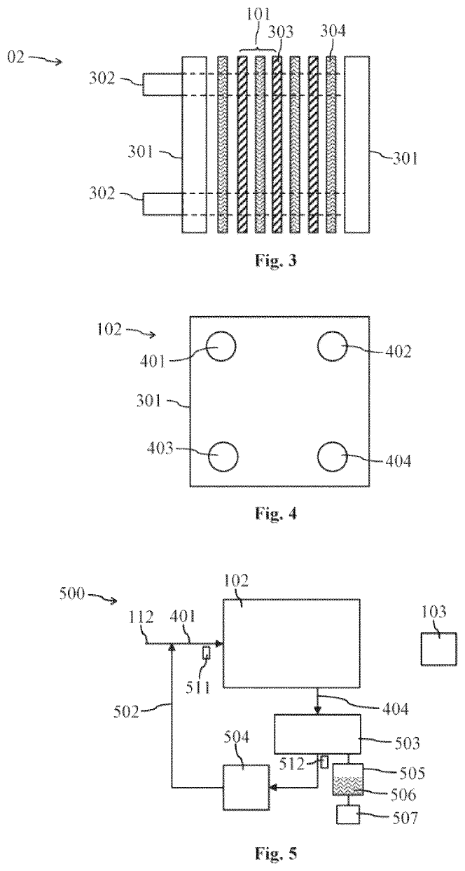

FIG. 3 shows a side view of the structure of an exemplary stack 102 of fuel cells. The stack 102 has end plates 301 between the numerous fuel cells 101. These end plates 301 can be used to hold or press the fuel cells 101 in the stack 102 together. As explained above, a fuel cell 101 can be formed by sides of two adjacent bipolar plates 303. An electrode membrane assembly (MEA) 304 can be placed between adjacent bipolar plates 303, which can contain the aforementioned gas-diffusion layer. The stack 102 of fuel cells also contains lines 302 through which the fuel 122 and/or oxidizers 212 can be conducted through the bipolar plates 303 to the individual fuel cells 101, and through which reaction products can be removed (again, through the bipolar plates 303) from the individual fuel cells 101.

The individual lines 302 can normally be accessed from one side of a stack 102 of fuel cells, to reduce installation space. FIG. 4 shows an exemplary stack 102 of fuel cells from the front. In particular, FIG. 4 shows the end plates 301 on a stack 102, where there is access to the different lines 302 in the stack 102. The stack 102 can contain a fuel intake line 401 (also referred to as the anode supply line), with which the fuel 211 can be supplied to the individual fuel cells 101. The stack 102 can also contain an oxidizer supply line 402 with which the oxidizers 212 can be supplied to the individual fuel cells 101. The stack 102 can also contain a reaction product removal line 403 with which the reaction products can be removed from the fuel cells 101 (for example, along with excess oxidizers 212, for example, air). The stack 102 can also contain a fuel removal line 404 (also referred to as the anode removal line), with which unused fuel 211 can be removed from the fuel cells 101 (for example, when rinsing the anode or for recirculating fuel).

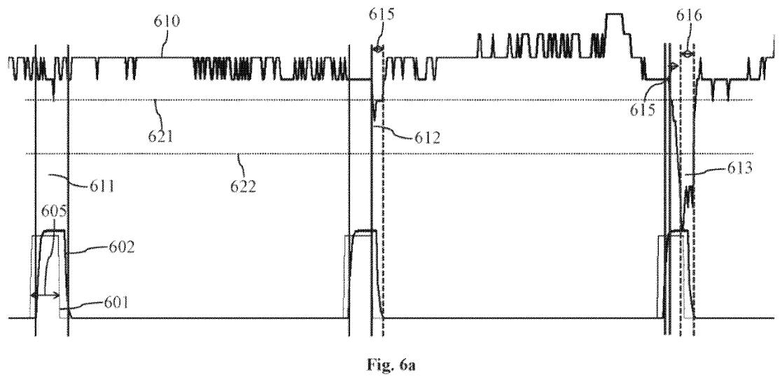

The fuel cell system 100 shown in FIG. 5, for example, contains an anode subsystem 500 (with one or more anode components), formed by the components of the fuel cell system 100 that conduct the fuel. An anode subsystem 500 can contain at least one anode supply line 401 leading to the anode intake (from at least one pressure tank 110, at least one take check valve (TCV) and potentially at least one pressure regulator), an anode space in the stack 102 of fuel cells, at least one anode exhaust line 404 leading away from the anode outlet, at least one water trap 503 (AWT), at least one anode purge valve 507 (APV), at least one active or passive fuel recirculation conveyor 504 (ARE or AFR), and/or at least one recirculation line 502, and potentially other elements. In the example shown in FIG. 5, the anode subsystem 500 contains a reservoir 505 for water 506, which receives the water 506 from the water trap 503.

The anode subsystem 500 primarily supplies and distributes fuel 211 to the electrochemically active surfaces of the anode space, and removes anode exhaust gases.

The fuel cell system 100 also contains a cathode subsystem (with one or more cathode components). The cathode subsystem is formed by the oxidizer conducting elements. A cathode subsystem can contain at least one oxidizer conveyor 205, at least one cathode supply line 402 leading to the cathode intake, at least one cathode exhaust gas line 403 leading away from the cathode outlet, a cathode space in the stack 102 of fuel cells, and other elements. The cathode subsystem primarily supplies and distributes oxidizers 212 to the electrochemically active surfaces of the cathode space and removes unused oxidizers 212 and/or reaction products.

As stated above, the amount of fuel 211 supplied to the anode space in the stack 102 of fuel cells can be adjusted to obtain the desired amount of electricity from the fuel cell system. The current anode state, in other words, the current fuel concentration in the gas mixture in the anode space can be used to precisely determine the amount of fuel 211 that is to be supplied (from the one or more pressure tanks 110).

The anode subsystem 500 can contain a first pressure sensor 511, as shown in FIG. 5, which is configured to detect a first gas pressure at the entry to the stack 102 of fuel cells, in particular at the entry to the anode space, in other words, at the anode supply line 401. The anode subsystem 500 can also contain a second pressure sensor 512, which is configured to detect a second gas pressure at the outlet from the stack 102 of fuel cells, in particular at the outlet from the anode space, in other words, the anode exhaust line 404. The second pressure sensor 512 can be placed downstream of the water trap 503, as shown in FIG. 5 (such that the second pressure sensor 512 and/or the sensor data from the second pressure sensor 512 are not impacted by water 506 in the anode exhaust line 404). It is advantageous to place the sensor in the immediate proximity of the water trap 503 and/or the purge valve 507. This results in a particularly precise determination of the gas pressure at the outlet from the stack 102 of fuel cells.

The fuel cell system 100 described in this application does not have a concentration sensor for determining the fuel concentration in the anodes 201, or the anode subsystem 500. To prevent fuel shortages, resulting in premature aging or damage to the stack 102 of fuel cells, the anode 201 can be operated with a higher fuel concentration, although this results in a lower fuel efficiency in the fuel system 100.

Fuel shortages can occur when water 506 accumulates (locally) in the anode 201. It is difficult to measure this accumulation of water, and an operating model will show that this existence or accumulation of water 506 in the anode 201 is the result of numerous different factors (for example, the purge strategy (for water removal from the anode 201), the stack operating temperature, component temperature, thermal gradients, vehicle inclination, operating point for the stack 102 of fuel cells, operating history, anode density, anode pressure, cathode pressure, cathode humidity, vehicle vibrations, vehicle acceleration, etc.)

Because of the large number of different factors acting on the water content in the anode 201, the current anode state is difficult to reliably determine with sensor data and/or a model with different operating points for the stack 102 of fuel cells. The accumulation of water 506 in the anode 201 may result in the stack 102 reaching a critical state with regard to water accumulation between about 10 seconds (when operating cold and/or at full power) and about 10 minutes (when hot and/or at the minimum power). In the critical state, the anode 201 has a shortage of fuel, and the stack 102 is therefore operating inefficiently, and/or ages prematurely. If the fuel shortage goes undetected, the stack 102 may become damaged. For this reason, the fuel cell system 100 may be immediately and entirely shut down if a shortage is suspected, thus limiting its availability.

Measures are described herein with which the water content in the anodes 201 in the stack 102 of fuel cells can be efficiently, precisely, and reliably monitored. This enables an efficient and reliable operation of the stack 102, in particular with regard to fuel concentration in the anodes 201 in the stack 102 of fuel cells.

FIG. 6a is a graph showing changes in pressure 610 in the anode intake line 401 or exhaust line 404 over time. The changes in pressure 610 can be detected by one or more pressure sensors 511, 512 in the anode subsystem 500. The anode purge valve 507 can be opened repeatedly to remove water 506 from the anodes 201 in the stack 102 of fuel cells, and/or from the reservoir 505 in the anode subsystem 500. The (control) device 103 can be configured to generate a (pulsed) control signal 601 for opening the anode purge valve 507. The length of the purge can correspond to the length or width 605 of the control signal 601.

The anode purge valve 507 is opened with the control signal 601. The extent to which the purge valve 507 is opened is normally dictated by the current 602 flowing through the purge valve 507. It is therefore possible to derive how wide and/or for how long the purge valve 507 was effectively opened during the purging process from the current 602.

Opening the purge valve 507 allows water 506 the escape reservoir 505. This keeps the pressure 610 constant in the anode supply line 401 and/or the anode exhaust line 404. This can be seen in the first purge, on the left side of FIG. 6a. A purge in which only water 506 is removed from the anode subsystem 500 can be referred to a first type of purge. The phase of the purge in which substantially only water 506 is removed from the anode subsystem 500 can be referred to as a first phase 611.

After most of the water 506 has been removed, an increasing amount of gas (in particular fuel 211) gets mixed into the flow through the purge valve 507. The outflow of gas from the anode 201 results in a drop in pressure 610 in the anode supply line 401 and/or the anode exhaust line 404. This can be seen in the second purge, in the middle of FIG. 6b. A purge in which a mixture of water 506 and gas is removed from the anode subsystem in a second phase 612 of the purge can be referred to as a second type of purge. The second phase 612 of the purge has a specific length 615 in the example shown in FIG. 6a.

It may be the case that only gas flows through the purge valve 507 in a third phase 613 of the purge. This third phase 613 can be detected by a significant drop in the gas pressure 610 in the anode supply line 401 and/or the anode exhaust line 404 (as shown in the purge on the right side of FIG. 6a). This can be referred to as a third type of purge. This purge therefore has a second phase 612 of a specific length 615, and a subsequent third phase 613 of a specific length 616.

To identify the type of purge and/or the phases 611, 612, 613 of a purge, the overall pressure 610 can be compared with one or more threshold values 621, 622. The purge enters a second phase 612, for example, if the pressure 610 falls below a first threshold value 621. The then purge enters a third phase 613 if the pressure falls below a second threshold value 622 (which is lower than the first threshold value 621).

The (control) device 103 for the fuel cell system 100 can be configured to purge repeatedly. The individual purges can also be analyzed. It is therefore possible to determine which type of purge has taken place. It is also possible to determine how long 615, 616 each of the phases 611, 612, 613 have lasted in each of the purges. One or more properties of one or more previous purges can then be determined in this manner. The fuel cell system 100 can subsequently be operated on the basis of one or more properties determined for the one or more previous purges. At this point, one or more operating parameters for one or more subsequent purges can be defined, based on the one or more properties of the one or more previous purges. By way of example, some of these operating parameters are the length 605 of the control signal 601 for a subsequent purge, and/or the repetition rate of the subsequent purges, or the time between successive subsequent purges.

When determining the one or more operating parameters, one or more of the following rules may be used:
the length 605 of the control signal 601 is increased and/or the time between purges (in other words, the control signal 601) is reduced if each of the one or more previous purges only contained a first phase 611 (and it is thus impossible to ensure that the water 506 has been completely removed from the anode subsystem 500); and/or
the length 605 of the control signal 601 is reduced and/or the time between purges (in other words, the control signal 601) is increased if each of the one or more previous purges contained a third phase 613 (and thus fuel 211 was also removed, in addition to water 506, from the anode subsystem 600, because the purge was excessive).

It should be noted that additional rules may be used to determine the one or more operating parameters for the one or more subsequent purges. In general, the one or more operating parameters for the subsequent purges can be set based on the properties of the previous purges. The intention thereof can be to reduce (in particular to zero) or set the lengths 615, 616 of the second and/or third phases 612, 613 of the purges to a target value. This efficiently and reliably prevents accumulation of water 506 in the anodes 201.

FIG. 6b is a graph showing purges 631 over time. FIG. 6b also shows whether the stack 102 of fuel cells is being operated at an optimal state 640 a different times (without a significant accumulation of water 506 and without a significant loss of fuel 211 through the purge valve 507), at an inefficient state 641 (without significant accumulation of water 506, but with a significant loss of fuel 211 through the purge valve 507), or at a critical state 642 (with a significant accumulation of water 506, but without a significant loss of fuel 211 through the purge valve 507).

As the graph showing the temporal states 645 of the stack 102 of fuel cells shows, the one or more operating parameters for the purges 631 described in this document result in the stack 102 of fuel cells being operated at nearly the optimal state 640.

The purge characteristics of each of the purges can therefore be analyzed in realtime in the control device 103, and the purges can be subdivided into different phases 611, 612, 613. A value for reaching a critical state 642 for the stack 102 of fuel cells can be derived from the lengths 615, 616 of these phases 611, 612, 613 and/or the results of previous purges. One or more measures can then be taken to avoid reaching this critical state 642 (for example, increasing the purge rate, increasing the pressure (in the anode 201), reducing the current generated by the stack 102 of fuel cells, etc.), thus increasing the stability of the system and/or the service life of the stack 102 of fuel cells. It is also possible to reduce the amount of fuel 211 stored (in particular in the safety buffer) in the stack 102 of fuel cells, thus increasing the efficiency and/or range of the fuel cell system 100.

Purges can be monitored continuously. As soon as a purge occurs, the current 602 flowing through the purge valve 507 can be used to determine how wide it is opened (because the extent to which a magnetic valve is opened typically depends on the current). The first phase 611, in which water is removed, starts as soon as the purge valve current 602 exceeds a threshold value (in other words, is greater than the minimum for opening the valve 507). Only water 506 is removed from the water trap 503 in this first phase 611. The length of the first phase 611 primarily depends on the amount of water in the water trap 503 and/or the pressure difference obtained with the purge valve 507. This pressure difference corresponds to the difference in the pressure in the anode in relation to the ambient pressure.

As soon as a significant drop in pressure 610 (in the anode supply line 401 and/or exhaust line 404) is detected, the purge enters a dynamic transition phase 612 (in other words, the second phase). The second phase 612 is a transition from water removal to gas removal. It is normally impossible to precisely determine how much of each portion—water or gas—is removed. The transition is normally dynamic, such that it is impossible to determine how much of each phase is removed (liquid or gas). The portions of the different phases typically shift continuously from the removal of liquid toward the removal of gas. It has been observed that the length 615 of the dynamic transition (in other words, the second phase 612) in different purges is substantially constant and/or the remains the same (as long as the purge is not stopped prematurely).

Once the transition phase 612 is completed, no significant amount of water is removed. A third phase 613 is then started, in which (only) gas is removed. There can still be water 506 in the water trap 503 in this third phase 613, but the pressure is no longer sufficient for removing water 506.

The state of the anodes can be evaluated on the basis of whether there is a second phase 612 or third phase 613 in a purge, and how long these phases 612, 613 last. If a critical state 642 is detected, this can be countered with one or more weighted measures (increasing the purge rate, increasing pressure, reducing current, etc.). If the anode state is within an inefficient range 641, the one or more countermeasures can be reduced. One or more fuel conservation measures can also be taken. This keeps the anodes 201 functioning at an optimal state 640.

When the vehicle is moving, external (dynamic) events may cause a pressure drop (for example, due to how the motor vehicle is being operated). If an external event is detected, the purge may be evaluated as critical due to the above weighting (for example, as a purge of the first type). Consequently, the evaluation may briefly leave the optimal state 640 and enter the inefficient range 641. This may prevent any severe damages. Over time, a potential error will be compensated for through a weighting of the evaluation (because external events rarely occur during a purge 631).

As shown in FIG. 6a, the changes in pressure 610 exhibit a typical curve during purges 631 of the first, second, and third types. In particular, there is an abrupt drop in pressure 610 during the second phase 612 and/or third phase 613 of the purge 631. At the other end of the purge 631, however, there is an abrupt increase in pressure 610. The pressure 610 substantially returns to its initial level after completion of the purge 631. Consequently, one or more reference curves can be obtained and stored for the pressure differences during purges 631 (for example, reference curves for purges 631 of the first, second, and/or third types).

The device 103 can be configured to check whether an external (dynamic) event has affected the fuel cell system 100 during a purge 631 (for example, while the vehicle containing the fuel cell system 100 is moving). Sensor data for the motor vehicle can be evaluated for this (for example, from an accelerator sensor and/or an inertia measuring unit). The device 103 can also be configured to check whether or not the changes in pressure 610 for a purge 631 correspond to a reference curve. If the changes in pressure 610 different from the one or more reference curves, it can be concluded that an external event has acted on the fuel cell system 100 during the purge 631, thus distorting the changes in pressure 610. The changes in pressure 610 can thus be classified as being either undistorted (and can thus be used to adjust the fuel cell system 100 operation), or distorted (and thus cannot be used, or can only be used to a limited extent for adjusting the fuel cell 100 operation).

The device 103 can be configured to classify a purge 631 as being of the first type if it has been detected that the change in pressure 610 for the purge 631 is distorted (due to external events). This results in a particularly reliable and/or safe operation of the fuel cell system 100 (even when the fuel cell system 100 is used in a motor vehicle).

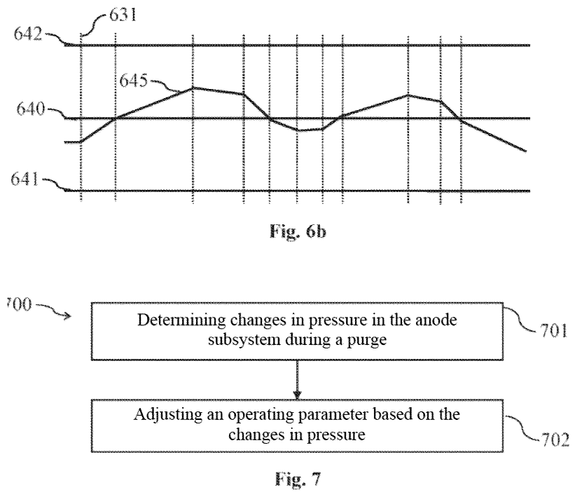

FIG. 7 shows a flow chart for a method 700 (that may be implemented with a computer) for operating a fuel cell system 100, which has a stack 102 of fuel cells and an anode subsystem 500 to which fuel 211 for the stack 102 is supplied.

The method 600 comprises determining 701 the changes in pressure 610 in the anode subsystem 500 (in particular in the anode supply line 401 and/or anode exhaust line 404) during at least one previous purge 631 in which water 506 is removed from the anode subsystem 500, in particular from the water trap 503.

The method 700 also comprises determining 702 one or more operating parameters for the fuel cell system 100 based on the detected changes in pressure 610.

The measures describe in this application can result in a particularly efficient and reliable operation of a stack 102 of fuel cells, in particular with regard to obtaining an optimized anode state 640.

The present disclosure is not limited to the exemplary embodiments disclosed herein. In particular, it should be noted that the description and the drawings are only intended to show examples of the principles of the proposed methods, devices, and systems.

List of Reference Symbols

| | |
|---|---|
| 100 | fuel cell system |
| 101 | fuel cell |
| 102 | stack of fuel cells |
| 103 | (control) device |
| 110 | pressure tank |
| 112 | fuel line |
| 201 | anode |
| 202 | cathode |
| 203 | separator |
| 204 | contact (electrode) |
| 205 | oxidizer conveyor |
| 211 | fuel (in particular hydrogen) |
| 212 | oxidizer |
| 301 | end plate |
| 302 | line |
| 303 | bipolar plate |
| 304 | electrode membrane unit |
| 401 | fuel supply line |
| 402 | oxidizer supply line |
| 403 | reaction product discharge line |
| 404 | anode exhaust line |
| 500 | anode subsystem |
| 502 | recirculation line |
| 503 | water trap |
| 504 | fuel recirculation conveyor |
| 505 | reservoir |
| 506 | water |
| 507 | valve |
| 511 | pressure sensor (upstream of the anode space in the |
| | stack of fuel cells) |
| 512 | pressure sensor (downstream of the anode space in the |
| | stack of fuel cells) |
| 601 | (pulsed) control signal |
| 602 | control current |
| 605 | length of the control signal |
| 610 | pressure |
| 611, 612, 613 | purge phases |
| 615, 616 | lengths of a phase |
| 621, 622 | pressure threshold value |
| 631 | purge |
| 640 | optimized state of the anode |
| 641 | inefficient state of the anode |
| 642 | critical state of the anode |
| 645 | actual state of the anode |
| 700 | method for operating a stack of fuel cells |
| 701-702 | steps of the method |

1-14. (canceled)

15. A device for operating a fuel cell system, the fuel cell system comprising a stack of fuel cells and an anode subsystem for receiving fuel for the stack, the device configured:
to open a purge valve to initiate a purge in which water is removed from the anode subsystem;
to determine changes in pressure in the anode subsystem during at least one previous purge in which the purge valve is open; and
to determine one or more operating parameters for the fuel cell system based on the detected changes in pressure, wherein the one or more operating parameters for the fuel cell system are for at least one subsequent purge in which the purge valve is open.

16. The device according to claim 15, wherein the device is configured:
to determine whether the at least one previous purge contained at least one phase in which fuel was removed from the anode subsystem based on the changes in pressure; and
to determine the one or more operating parameters for the fuel cell system based on whether the at least one previous purge contained at least one phase in which fuel was removed from the anode subsystem.

17. The device according to claim 15, wherein the device is configured:
to compare the changes in pressure with at least one pressure threshold value; and
to determine the one or more operating parameters for the fuel cell system based on a comparison of the changes in pressure with the at least one pressure threshold value.

18. The device according to claim 17, wherein the device is configured:
to compare the changes in pressure with a first pressure threshold value;
to compare the changes in pressure with a second pressure threshold value, wherein the second pressure threshold value is lower than the first pressure threshold value;
to determine whether the at least one previous purge contained a second phase in which fuel, in addition to water, was removed from the anode subsystem, and/or to determine a length of the second phase;
to determine whether the at least one previous purge contained a third phase in which fuel, in addition to water, was removed from the anode subsystem, and/or to determine a length of the third phase; and
to determine the one or more operating parameters for the fuel system based on:
whether the at least one previous purge contained the second phase and/or the third phase; and/or
the length of the second phase and/or the third phase.

19. The device according to claim 15, wherein the device is configured
to determine one or properties of the at least one previous purge based on the changes in pressure, wherein the one or more properties comprise:
whether the at least one previous purge only contained a first phase, in which water was removed from the anode subsystem;
whether the at least one previous purge contained a second phase in which fuel and water were removed from the anode subsystem;
whether the at least one previous purge contained a third phase in which fuel was removed from the anode subsystem; and/or
lengths of the first phase, the second phase, and/or the third phases; and
to determine the one or more operating parameters based on the one or more properties of the at least one previous purge.

20. The device according to claim 15, wherein the device is configured to determine the one or more operating parameters for the fuel cell system to give a target value to a length of a phase in at least one subsequent purge in which fuel is removed from the anode subsystem.

21. The device according to claim 15, wherein the one or more parameters for the fuel system comprise:
a length of the at least one subsequent purge;
a time between the at least one subsequent purge and the at least one previous purge;
a repetition rate for the at least one subsequent purge;
an extent to which a purge valve is opened during the at least one subsequent purge;
a valve for the pressure in the anode subsystem; and/or
a value for an electricity output obtained with the stack of fuel cells.

22. The device according to claim 21, wherein the device is configured:
to increase the length and/or the repetition rate for the at least one subsequent purge, and/or reduce a time between subsequent purges if the at least one previous purge only contained one phase; and/or
to reduce the length and/or the repetition rate of the at least one subsequent purge, and/or increase a time between subsequent purges if the at least one previous purge contained a third phase.

23. The device according to claim 15,
wherein the anode subsystem comprises a water trap that is configured to separate water from anode exhaust in the stack of fuel cells; and
wherein the anode subsystem comprises a purge valve designed to remove water in the water trap from the anode subsystem.

24. The device according to claim 23, wherein the anode subsystem is configured such that
fuel is removed from the anode subsystem in at least one phase following a first phase in a purge, in which water is removed from the anode subsystem, if the purge lasts longer than the first phase; and/or
pressure of fuel in an anode supply line for an anode in the stack of fuel cells and/or pressure of exhaust in an anode exhaust line exiting the anode drops during a phase of the purge in which fuel is removed from the anode subsystem.

25. The device according to claim 15,
wherein the anode subsystem comprises at least one pressure sensor that is configured to detect pressure of fuel in an anode supply line for an anode in the stack of fuel cells, and/or pressure of exhaust gas in an anode exhaust line exiting the anode; and
wherein the device is configured to determine the changes in pressure in the anode subsystem during the at least one previous purge based on sensor data from the at least one pressure sensor.

26. The device according to claim 15, wherein the device is configured:
to check whether the changes in pressure detected for the at least one previous purge are distorted or not, in particular due to an external dynamic event; and
to take into account whether the changes in pressure were distorted when determining the one or more operating parameters for the fuel cell system.

27. The device according to claim 26, wherein the device is configured to determine that the at least one previous purge had no phase in which fuel was removed from the anode subsystem, if the device detected that the changes in pressure during the at least one previous purge are distorted.

28. A method for operating a fuel cell system, the fuel cell system comprising a stack of fuel cells and an anode subsystem for receiving fuel for the stack of fuel cells, the method comprising:
determining changes in pressure in the anode subsystem during at least one previous purge for removing water from the anode subsystem, wherein the at least one previous purge is caused by opening a purge valve; and
determining one or more operating parameters for the fuel cell system based on the changes in pressure, wherein the one or more operating parameters for the fuel cell system comprise one or more operating parameters for one or more subsequent purges caused by opening the purge valve.

29. The method of claim 28, further comprising:
opening a purge valve to initiate a purge in which water is removed from the anode subsystem.

30. The method of claim 28, further comprising:
determining whether the at least one previous purge contained at least one phase in which fuel was removed from the anode subsystem based on the changes in pressure; and
determining the one or more operating parameters for the fuel cell system based on whether the at least one previous purge contained at least one phase in which fuel was removed from the anode subsystem.

31. The method of claim 28, further comprising:
comparing the changes in pressure with at least one pressure threshold value; and
determining one or more parameters for the fuel cell system based on a comparison of the changes in pressure with the at least one pressure threshold value.

32. The method of claim 31, further comprising:
comparing the changes in pressure with a first pressure threshold value;
comparing the changes in pressure with a second pressure threshold value, the second pressure threshold value lower than the first pressure threshold value;
determining whether the at least one previous purge contained a second phase in which fuel, in addition to water, was removed from the anode subsystem, and/or a length of the second phase;
determining whether the at least one previous purge contained a third phase in which fuel was removed from the anode subsystem, and/or a length of the third phase; and
determining the one or more operating parameters for the fuel cell system based on whether the at least one previous purge contained a second phase and/or the third phase and/or the length of the second phase and/or the third phase.

33. The method of claim 28, further comprising:
determining one or more properties of the at least one previous purge based on the changes in pressure, the one or more properties comprising:
whether the at least one previous purge only contained a first phase, in which water was removed from the anode subsystem;
whether the at least one previous purge contained a second phase, in which fuel and water were removed from the anode subsystem;
whether the at least one previous purge contained a third phase, in which fuel was removed from the anode subsystem; and/or
the length of the third phase, the second phase, and/or the third phase; and
determining the one or more operating parameters for the fuel cell system based on the one or more properties of the at least one previous purge.
